(19) United States
(12) Patent Application Publication
(10) Pub. No.: US 2013/0194492 A1
(43) Pub. Date: Aug. 1, 2013

(54) Method and System for Producing Archiving on Film

(71) Applicants: Chris Scott Kutcka, Pasadena, CA (US); Joshua Pines, San Francisco, CA (US)

(72) Inventors: Chris Scott Kutcka, Pasadena, CA (US); Joshua Pines, San Francisco, CA (US)

(73) Assignee: THOMSON LICENSING, Issy de Moulineaux (FR)

(21) Appl. No.: 13/878,653

(22) PCT Filed: Oct. 14, 2011
(86) PCT No.: PCT/US11/56269

§ 371 Date: Apr. 10, 2013

Related U.S. Application Data
(60) Provisional application No. 61/393,865, filed on Oct. 15, 2010.
(60) Provisional application No. 61/393,858, filed on Oct. 15, 2010.

(51) Int. Cl. H04N 7/01

(52) U.S. Cl. CPC H04N 7/01
USPC 348/441

(57) ABSTRACT

A method and system are disclosed for archiving video content to film and recovering the video from the film archive. Video content and a characterization pattern associated with the content are provided as encoded data, which is recorded onto a film and processed to produce a film archive. By encoding the video data using a non-linear transformation between video codes and film density codes, the resulting film archive allows a film print to be produced at a higher quality compared to other film archive techniques. The characterization pattern contains spatial, temporal and colorimetric information relating to the video content, and provides a basis for recovering the video content from the film archive.

### CROSS-REFERENCE TO RELATED APPLICATIONS

The present patent application claims the benefit of priority from U.S. Provisional Patent Application Ser. No. 61/393,865, “Method and System for Producing Video Archive on Film”, and from U.S. Provisional Patent Application Ser. No. 61/393,858, “Method and System of Archiving Video to Film”, both filed on Oct. 15, 2010. The teachings of both provisional patent applications are expressly incorporated herein by reference in their entirety.

### TECHNICAL FIELD

The present invention relates to a method and system of creating film archives of video content, and recovering the video content from the film archives.

### BACKGROUND

Although there are many media formats that can be used for archival purpose, film archive still has advantages over other formats, including a proven archival lifetime of over fifty years. Aside from degradation problems, other media such as video tape and digital formats may also become obsolete, with potential concerns as to whether equipment for reading the magnetic or digital format are still available in the future.

Tradition methods for transferring video to film involve photographing video content on a display monitor. In some cases, this means photographing color video displayed on a black and white monitor through separate color filters. The result is a photograph of the video image. A telecine is used for retrieving or recovering the video image from the archive photograph. Each frame of film is viewed by a video camera and the resulting video image can be broadcast live, or recorded. The drawback to this archival and retrieval process is that the final video is “a video camera's image of a photograph of a video display”, which is not the same as the original video.

Recovery of video content from this type of film archive typically requires manual, artistic intervention to restore color and original image quality. Even then, the recovered video often exhibit spatial, temporal and/or colorimetric artifacts. Spatial artifacts can arise due to different reasons, e.g., if there is any spatial misalignment in displaying the video image, in the photographic capture of the video display, or the video camera capture of the photographic archive.

Temporal artifacts can arise from photographs of an interlaced video display due to the difference in time at which adjacent line pairs are captured. In cases where the video frame rate and film frame rates are not 1:1, the film images may produce temporal artifacts resulting from the frame rate mismatch, e.g., telecine judder. This can happen, for example, when the film has a frame rate of 24 frames per second (fps) and video has a frame rate of 60 fps (in US) or 50 fps (in Europe), and one frame of a film is repeated for two or more video frames.

Additionally, colorimetric artifacts are introduced because of metamerisms between the display, film, and video camera, i.e., different colors generated by the display can appear as the same color to the film, and again different colors in the archive film can appear as the same color to the video camera.

### SUMMARY OF THE INVENTION

These problems in the prior art approach are overcome in a method of the present principles, in which the dynamic range of the film medium is used to preserve digital video data in a self-documenting, accurately recoverable, degradation resistant, and human-readable format. According to the present principles, a film archive is created by encoding at least the digital video data to film density codes based on a non-linear relationship (e.g., using a color lookup table), and providing a characterization pattern associated with the video data for use in decoding the archive. The characterization pattern may or may not be encoded with the color lookup table. The resulting archive has sufficient quality suitable for use with telecine or a film printer for producing a video of film image that closely approximates the original video, while allowing the video to be recovered with negligible spatial, temporal, and colorimetric artifacts compared with the original video, and requires no human intervention for color restoration or gamut remapping.

One aspect of the invention provides a method for archiving video content on film, including: encoding digital video data by at least converting the digital video data into film density codes based on a non-linear transformation; providing encoded data that includes the encoded digital video data and a characterization pattern associated with the digital video data; recording the encoded data onto film in accordance with the film density codes; and producing a film archive from the film having the recorded encoded data.

Another aspect of the invention provides a method for recovering video content from a film archive, including: scanning at least a portion of the film archive containing digital video data encoded as film-based data and a characterization pattern associated with the digital video data; in which the digital video data has been encoded into film-based data by a non-linear transformation; and decoding the film archive based on information contained in the characterization pattern.

Yet another aspect of the invention provides a system for archiving video content on film, which includes: an encoder for producing encoded data containing film-based data corresponding to digital video data and a characterization pattern associated with the video data, wherein the digital video data and pixel values of the characterization pattern are encoded to the film-based data by a non-linear transformation; a film recorder for recording the encoded data onto a film; and a film processor for processing the film to produce a film archive.

Yet another aspect of the invention provides a system for recovering video content from a film archive, which includes: a film scanner for scanning the film archive to produce film-based data; a decoder for identifying a characterization pattern from the film-based data, and for decoding the film-based data based on the characterization pattern to produce video data for use in recovering the video content; in which the film-based data is related to the video data by a non-linear transformation.

### BRIEF DESCRIPTION OF THE DRAWINGS

The teachings of the present invention can be readily understood by considering the following detailed description in conjunction with the accompanying drawings, in which:

FIG. 1A illustrates a system for archiving video to film suitable for use in a telecine or for printing;

FIG. 1B illustrates a system for recovering video previously archived to film and a system for creating a film print from the archive;

FIG. 2 illustrates a sequence of progressive frames of video archived to film;

FIG. 3 illustrates a sequence of field-interlaced frames of video archived to film;

FIG. 4A illustrates a characterization pattern for use at the head of a progressive frame video archive on film;

FIG. 4B is an expanded view of a portion of FIG. 4A;

FIG. 5 illustrates a process for creating a film archive of video using a color look-up table (cLUT) on video data and the characterization pattern;

FIG. 6 illustrates a process for recovering video from a film archive created by the process of FIG. 5;

FIG. 7 illustrates a process for creating a film archive of video using a cLUT on video data only;

FIG. 8 illustrates a process for recovering video from a film archive created by the process of FIG. 7;

FIG. 9 illustrates a process for creating a first example of cLUT, for use in a method of producing a film archive suitable for making a film print;

FIG. 10 illustrates a process for creating another example of cLUT, suitable for use in a method of producing a film archive suitable for making a film print;

FIG. 11 is a graph representing an exemplary cLUT; and

FIGS. 12A-B illustrate characteristic curves of some film stocks.

### DETAILED DESCRIPTION

The present principles provide a method and system for producing a film archive of video content, and for recovering the video content from the archive. Video data is encoded, then recorded onto film along with a characterization pattern associated with the video data, which allows recovery of the original video data. The video data is encoded so that telecine or film print generated from the film archive can produce a video or film image that better approximates the original video, with only a slight compromise to the recoverability of the original video data. For example, there may be an increase in quantization noise for at least portion of the video data. In some embodiments, there may be a reduction in quantization noise for some portions of the video data, but with a net increase overall. When the film is developed, the resulting film provides an archival quality storage medium, which can be read through a telecine, or printed photographically. When the archive is scanned for recovery, the characterization pattern provides the basis for decoding the film frames to video. Subsequent decoding of the film frame scan data produces video similar to the original video, even in the presence of many decades of fading of the film dyes.

Unlike prior art techniques that renders video content as a picture recorded on film, e.g., by taking a picture of each video frame displayed on a monitor using a kinescope or cine camera, the archive production system of the present invention treats the video signal as numerical data, which can be recovered with substantial accuracy by using the characterization pattern.

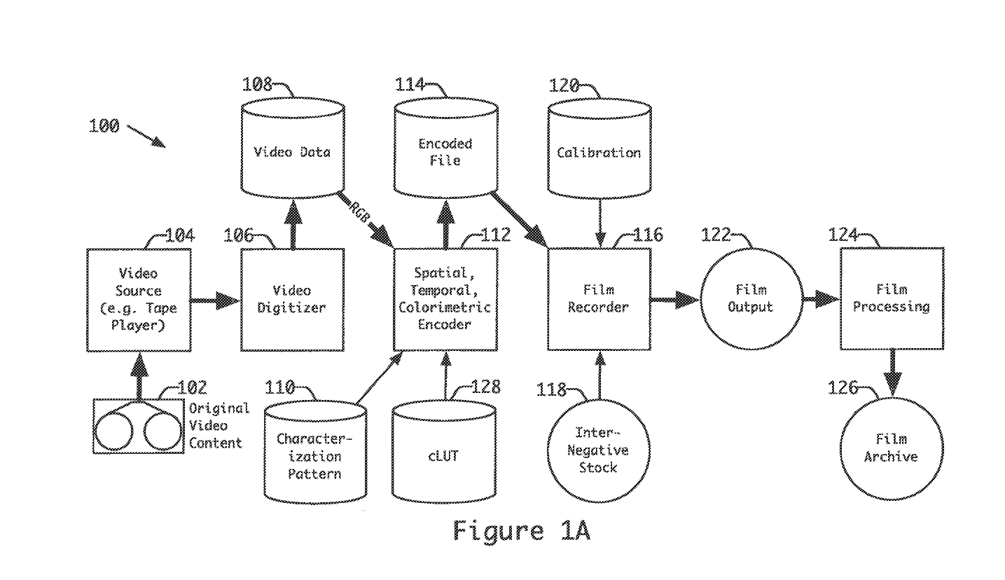

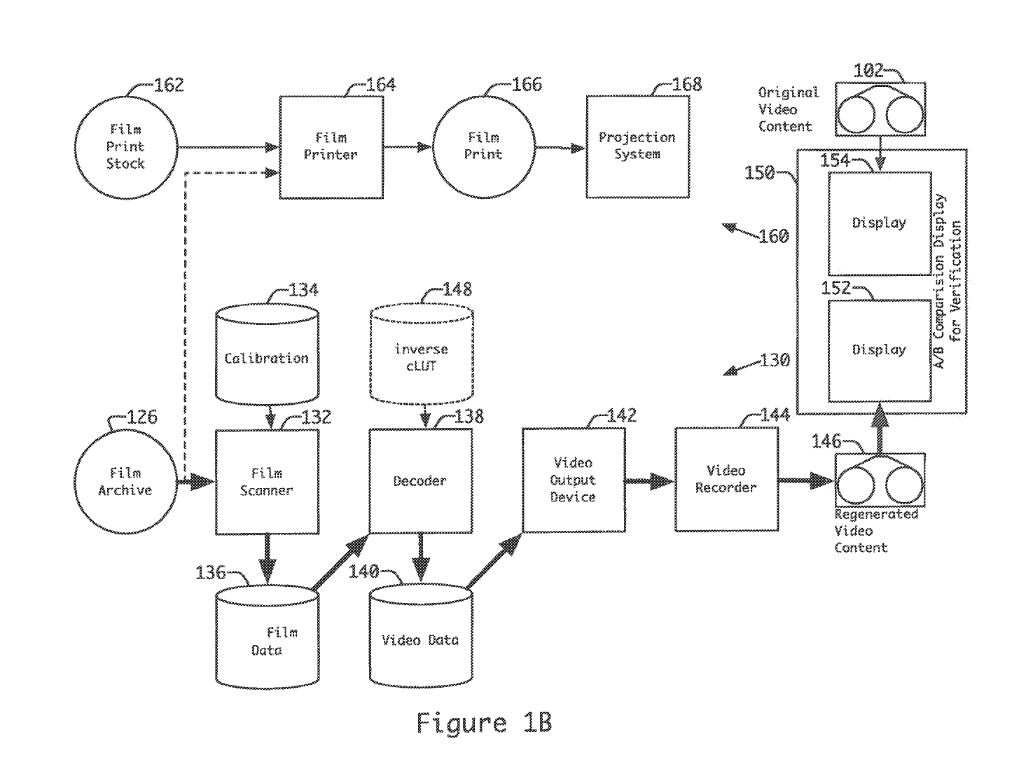

FIG. 1A shows one embodiment of a film archive system 100 of the present invention, which includes an encoder 112 for providing an encoded file 114 containing video content 108 and a characterization pattern 110, a film recorder 116 for recording the encoded file, and a film processor 124 for processing the recorded file and producing a film archive 126 of the video content. As used herein in conjunction with the overall activities of encoder 112, the term “encoding” includes transforming from video data format into film data format, e.g., from Rec. 709 codes (representing fractional contributions of the three video display primaries) to film density codes (representing respective densities of three dyes in a film negative, e.g., Cineon code, with values in the range of 0 to 1023), and spatial and temporal formatting (e.g., as pixels in the video data 108 and characterization pattern 110 are mapped to appropriate pixels in the image space of the film recorder 116). In this context, temporal formatting refers to the mapping of pixels from the video to the film image space in accordance with the time sequence of the video data, e.g., with consecutive pictures in the video being mapped into consecutive frames of film. For progressive video, individual video frames are recorded as single film frames, while interlaced video is recorded as separate fields, e.g., the odd rows of pixels forming one field and the even rows of pixels forming another field, with the separate fields of a frame recorded within the same film frame.

Original video content 102 is provided to the system 100 via a video source 104. Examples of such content include television shows presently stored on video tape, whether in digital or analog form. The video source 104 (e.g., a videotape player), suitable for use with the format of original video content 102, provides the content to video digitizer 106 to produce video data 108. In one embodiment, video data 108 is in, or convertible to, RGB (red, green, blue) code values because they result in negligible artifacts compared to other formats. Although video data 108 can be provided to the encoder 112 in non-RGB formats, e.g., as luminance and chrominance values, various imperfections and crosstalk in the archiving and video conversion processes using these formats can introduce artifacts in the recovered video.

Video data 108 can be provided by digitizer 106 in different video formats, including, for example, high-definition formats such as “Rec. 709”, which provide a convention for encoding video pixels using numerical values. According to the Rec. 709 standard (Recommendation BT.709, published by the International Telecommunications Union, Radiocommunication Sector, or ITU-R, of Geneva, Switzerland), a compatible video display will apply a 2.4-power function (also referred to as having a gamma of 2.4) to the video data, such that a pixel with an RGB code value x (e.g., from digitizer 106), when properly displayed, will produce a light output proportional to x^{2.4}. Other video standards provide other power functions, for example, a monitor compliant with the sRGB standard will have a gamma of 2.2. If the video content from the source is already provided in digital form, e.g., the SDI video output (“Serial Digital Interface”) on professional grade video tape players, the video digitizer 106 can be omitted.

In some configurations, the original video content 102 may be represented as luminance and chrominance values, i.e., in YCrCb codes (or, for an analog representation, YPrPb), or other encoding translatable into RGB code values. Furthermore, original video content 102 may be sub-sampled, for example 4:2:2 (where for each four pixels, luminance “Y” is represented with four samples, but the chromatic components “Cr” and “Cb” are each sampled only twice), reducing the bandwidth required by ⅓, without significantly affecting image quality.

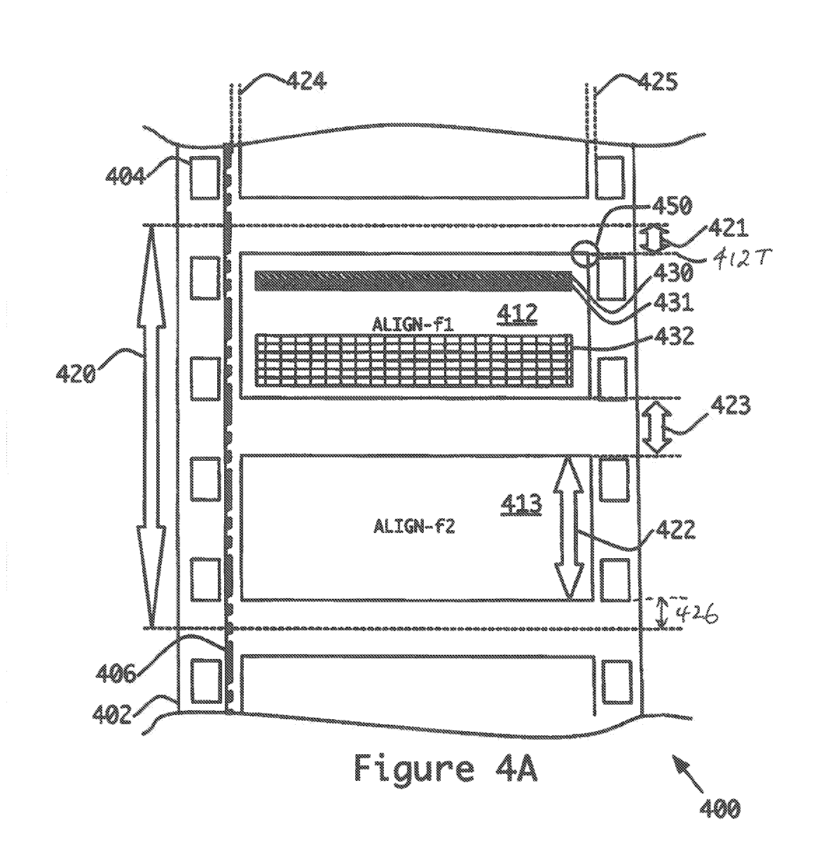

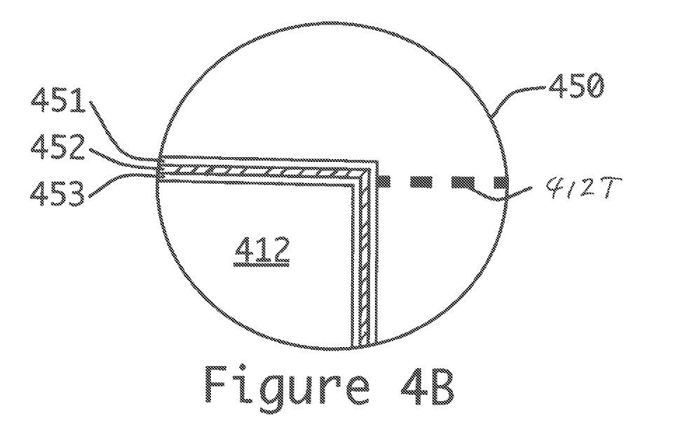

Characterization pattern 110, which is associated with the video data of the content, and to be discussed in greater detail below in conjunction with FIGS. 4A-B, is provided to an encoder 112 to establish the spatial, colorimetric, and/or temporal configurations (or at least one of these configurations) of an archive at the time of its creation.

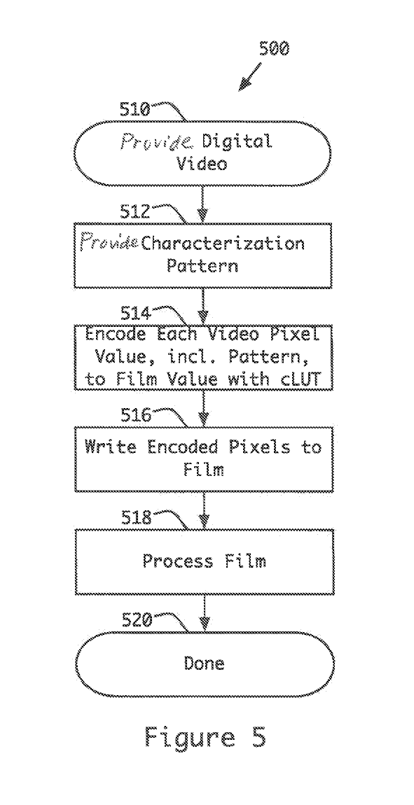

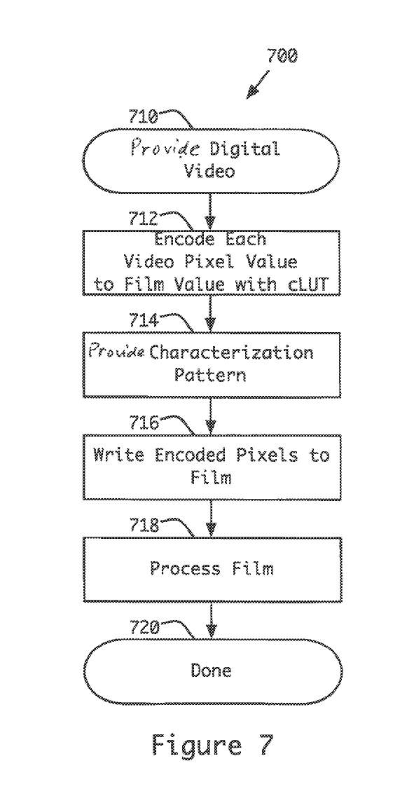

Furthermore, a color look-up table (cLUT) 128 is provided to encoder 112, which encodes video data 108 in accordance with characterization pattern 110 and cLUT 128. The video data is encoded or processed using cLUT 128, which provides a non-linear transformation for converting video data from digital video codes to film density codes. Encoded file 114 contains the encoded video data and characterization pattern 110, which may or may not be processed or encoded with cLUT 128, as discussed below in conjunction with FIGS. 5 and 7. It is also possible to include only a portion of the characterization pattern in the encoded file, as long as there is sufficient information available to a decoder for decoding the film archive.

In encoded file 114, characterization pattern 110 may be positioned ahead of the encoded video data, e.g., as in FIGS. 4A-B, or may be provided in the same film frame as the encoded video data (not shown). The use of a cLUT, or more generally, a non-linear transformation, in this method results in a film archive that is optimally suited for making a film print of relatively high quality. Such a film print can be projected for visual comparison with the video content recovered from the film archive, if desired.

The spatial and temporal encoding by encoder 112 is presented in characterization pattern 110, which indicates where each frame of video information is to be found in each frame of the archive. If interlaced fields are present in video content 102, then characterization pattern 110 also indicates a spatial encoding performed by encoder 112 of the temporally distinct fields.

Such information can be provided as data or text contained in the pattern 110, or based on the pattern's spatial configuration or layout, either of which is appropriate for machine or human readability. For example, pattern 110 may contain text that relates to location and layout of the image data, e.g., saying, “Image data is entirely within, and exclusive of, the red border” (e.g., referring to FIG. 4B, element 451), and such specific information can be particularly helpful to a person unfamiliar with the archive format. Text can also be used to annotate the pattern, for example, to indicate the format of the original video, e.g., “1920×1080, interlaced, 60 Hz,” and time-code for each frame can be printed (where at least a portion of the calibration pattern is being provided periodically throughout the archive).

Furthermore, specific elements (e.g., boundaries or indicating lines) can be used to indicate to encoder 112 the physical extent or positions of data, and the presence of two such elements corresponding to two data regions in a frame (or one double-height element), can be used to indicate the presence of two fields to be interlaced per frame.

In another embodiment, data such as a collection of binary values may be provided as light and dark pixels, optionally combined with geometric reference marks (indicating a reference frame and scale for horizontal and vertical coordinates). Such a numerically based position and scale can be used instead of graphically depicting borders for data regions. Such a binary pattern can also represent appropriate SMPTE time-code for each frame.

With respect to the colorimetric encoding by encoder 112, characterization pattern 110 includes patches forming a predetermined spatial arrangement of selected code values. The selected code values (e.g., video white, black, gray, chroma blue, chroma green, various flesh tones, earth tones, sky blue, and other colors) could be selected because they are either crucial for correct technical rendering of an image, important to human perceptions, or exemplary of a wide range of colors. Each predetermined color would have a predetermined location (e.g., where that color will be rendered within the patch) so the decoder knows where to find it. The code values used for these patches are selected to substantially cover the full extent of video code values, including values at or near the extremes for each color component, so as to allow interpolation or extrapolation of the non-selected values with adequate accuracy, especially if the coverage is sparse. If the characterization pattern is also encoded using the cLUT, the full extent of the video codes (corresponding to the video content being archived) can be represented in patches before encoding by the cLUT, e.g., the code values are selected to be a sparse representation of substantially the entire extent of video codes. In the case where the characterization pattern is not encoded or processed using the cLUT, the patches should have predetermined density values and any deviation from this can be used to determine a compensation for any drift in the archive (e.g., from aging, or from variations in film processing). A compensation so determined, when used in conjunction with the inverse cLUT, will allow accurate recovery of the original video data codes. Subsets of the patches supplied in characterization pattern 110 may present color components separately or independently of other components, i.e., with the value of the other components being fixed or at zero) and/or in varying combinations (e.g., grey scales where all components have the same value; and/or different collections of non-grey values).

One use of characterization pattern 110 presenting components separately is to allow an easy characterization of linearity and fading of color dyes as an archive has aged, along with any influence of dye crosstalk. However, patches with various combinations of color components can also be used to convey similar information. The spatial arrangement and code values of color patches in the characterization pattern are made available to a decoder for use in recovering video from the film archive. For example, information regarding the position (absolute or relative to a reference position) of a patch and its color or code value representation will allow the decoder to properly interpret the patch, regardless of intervening problems with overall processing variations or archive aging.

Whether video digitizer 106 produces code values in RGB, or some other representation, the video data 108 includes code values that are, or can be converted to, RGB code values. The RGB code values are typically 10 bit representations, but the representations may be smaller or larger (e.g., 8-bits or 12-bits).

The range of RGB codes of video data 108 (e.g., as determined by the configuration of the video digitizer 106, or a processing selected when converted to RGB, or predetermined by the representation of the original video content 102 or video source 104) should correspond to the range of codes represented in characterization pattern 110. In other words, the characterization pattern preferably covers at least the range of codes that the video pixel values might be using, so that there is no need to extrapolate the range. (Such extrapolation is unlikely to be very accurate. For example, if the pattern covers codes in a range of 100-900, but the video covers a range of 64-940, then in the end sub-ranges 64-100 and 900-940 of the video, there is a need to extrapolate from the nearest two or three neighbors (which might be, say, every hundred counts). The problem arises from having to estimate a conversion for video code 64 based on conversions for video codes 100, 200, and 300, etc., which assumes that the film behavior at video code 64 is responding to light in a way similar to how it responds at video codes 100, 200, etc., which, is probably not the case because a film's characteristic curve typically has non-linear response near the low and high exposure limits.

For example, if characterization pattern 110 uses 10-bit code values, and if the coding for video data 108 was only 8-bits, then as part of the encoding operation by encoder 112, video data 108 may be left-shifted and padded with zeroes to produce 10-bit values, where the eight most significant bits correspond to the original 8-bit values. In another example, if the characterization pattern 110 uses fewer bits than the representation of video data 108, then the excess least significant bits of video data 108 can be truncated (with or without rounding) to match the size of the characterization pattern representation.

Depending on the specific implementation or design of the pattern, incorporation of the characterization pattern 110 encoded with cLUT 128 into encoded file 114 can provide self-documenting or self-sufficient information for interpretation of an archive, including the effects of age on the archive. For example, the effects of age can be accounted for based on colorimetric elements such as a density gradient representing the full range of code values for the video data, since elements in the characterization pattern would have the same aged effect as video images in the archive. If color patterns are designed to represent the entire color range for the video content, it is also possible to decode the pattern algorithmically or heuristically, without the decoder having prior knowledge or predetermined information regarding the pattern. In another embodiment, text instructions for archive interpretation can be included in the characterization pattern, so that a decoder can decode the archive without prior knowledge about the pattern.

In an embodiment in which the characterization pattern 110 has not been encoded with cLUT 128 (but instead, encoded using a linear transformation between digital pixel values and film density codes or using an identity transform), the effect of age on the archive is accounted for by use of density gradient in the characterization pattern, but additional documentation or knowledge in the form of the original cLUT 128 or its inverse (element 148 in FIG. 1B) will be needed for interpretation of an archive.

The encoded file 114, whether stored in a memory device (not shown) and later recalled or streamed in real-time as encoder 112 operates, is provided to film recorder 116, which exposes color film stock 118 in accordance with the encoded file data to produce film output 122 (i.e., exposed film) having the latent archive data, which is developed and fixed in chemical film processor 124 to produce film archive 126.

The purpose of film recorder 116 is to accept a density code value for each pixel in encoded file 114 and produce an exposure on film stock 118 that results in a specific color film density on film archive 126, which is produced by film processor 124. To improve the relationship or correlation between code value presented to the film recorder 116 and the resulting density on the film archive, film recorder 116 is calibrated using data 120 from a calibration procedure. The calibration data 120, which can be provided in a look-up table for converting film density code to film density, depends on the specific manufacture of film stock 118 and the expected settings of the film processor 124. To the extent that film stock 118 has any non-linearity in its characteristic curves, i.e., the relationship between log₁₀ exposure (in lux-seconds) and density (which is the log₁₀ of the reciprocal of the transmissivity), calibration data 120 produces a linearization such that a given change in density code value produces a fixed change in density, across the entire range of density code values. Furthermore, the calibration data may include a compensation matrix for crosstalk in the dye sensitivity.

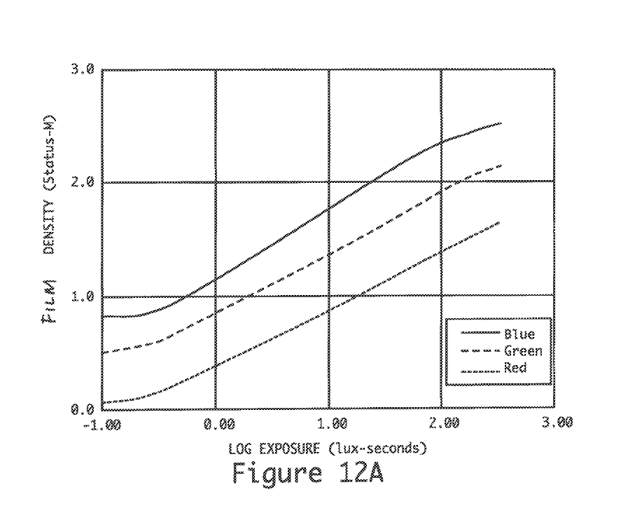

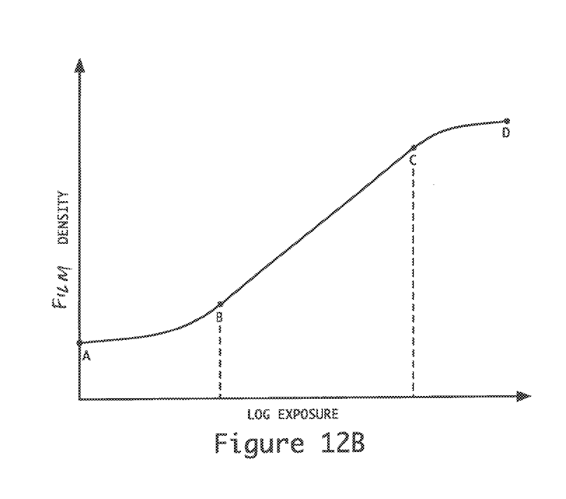

In one embodiment, film stock 118 is an intermediate film stock (e.g., Eastman Color Internegative II Film 5272, manufactured by Kodak of Rochester, N.Y.), especially one designed for use with a film recorder (e.g., Kodak VISION3 Color Digital Intermediate Film 5254, also by Kodak), and is engineered to have a more linear characteristic curve. FIG. 12A shows the characteristic curves for this film for the blue, green and red colors at certain exposure and processing conditions.

Other types of film stocks may be used, with different corresponding calibration data 120. FIG. 12B shows another example of a characteristic curve (e.g., for one color) for these stocks, which may exhibit a shorter linear region, i.e., a smaller range of exposure values within the linear region BC, compared to that of FIG. 12A. In addition, the characteristic curve has a more substantial (e.g., over a larger range of exposures) “toe” region AB with diminished film sensitivity at low exposures, i.e., a smaller slope in the curve where an incremental exposure produces a relatively small incremental density compared to the linear region BC, and a “shoulder” region CD at higher exposures, with a similarly diminished film sensitivity as a function of exposure. For these stocks, the overall characteristic curve has a more pronounced sigmoidal shape. Nonetheless, corresponding calibration data 120 can be used to linearize the relationship between pixel code value and density to be recorded on the film archive. However, the resulting film archive 126 will be more sensitive to variations in the accuracy of film recorder 116 and film processor 124. Furthermore, since the linear region BC of this characteristic curve is steeper than that of the Kodak Internegative II Film 5272, i.e., the variation in density will be greater for a given incremental change in exposure, such stock will be more prone to noise in this intermediate region (and less so in the low or high exposure regions).

Thus, to generate a film archive, a numeric density code value ‘c’ from encoded file 114 (e.g., corresponding to the amount of red primary in the color of a pixel) is provided to film recorder 116 for conversion to a corresponding film-based parameter, e.g., film density (often measured in units called “status-M”), based on calibration data 120. The calibration provides a precise, predetermined linear relationship between density code value ‘c’ and a resulting density. In one commonly used example, the film recorder is calibrated to provide an incremental density of 0.002 per incremental code value. Exposures required for generating desired film densities are determined from the film characteristic curve (similar to FIGS. 12A-B) and applied to the film stock, which results in a film archive after processing by the film processor 124. To retrieve the video content from the film archive, film densities are converted back into the code values ‘c’ by a calibrated film scanner, as discussed below in the archive retrieval system of FIG. 1B.

FIG. 1B shows an example of an archive reading or retrieval system 130 for recovering video from a film archive, e.g., film archive 126 produced by archive production system 100. Film archive 126 may have recently been made by film archive system 100, or may have aged substantially (i.e., archive reading system 130 may be operating on archive 126 some fifty years after the creation of the archive). Since the video data is converted from digital video to film density codes based on a non-linear transformation, e.g., using cLUT, the film archive of the present invention has improved quality (compared to other archives that use a linear transformation between video data and film density codes) such that a film print generated from the archive by film print output system 160 has sufficient quality suitable for projection or display.

Film archive 126 is scanned by film scanner 132 to convert film densities to film data 136, i.e., represented by density code values. Film scanner 132 has calibration data 134, which, similar to calibration data 120, is a collection of parameter values (e.g., offsets, scalings, which may be non-linear, perhaps a color look-up table of its own) that linearizes and normalizes the response of the scanner to film density. With a calibrated scanner, densities on film archive 126 are measured and produce linear code values in film data 136, i.e., an incremental code value represents the same change in density at least throughout the range of densities in film archive 126. In another embodiment, calibration data 134 may linearize codes for densities throughout the range of densities measurable by film scanner 132. With a properly calibrated scanner (e.g., with a linear relationship between density code values and film densities), an image portion recorded with a density corresponding to a code value ‘C’ from the encoded file 114 is read or measured by scanner 132, and the resulting numeric density code value, exclusive of any aging effects or processing drift, will be about equal to, if not exactly, ‘C’.

To establish the parameters for spatial and temporal decoding, decoder 138 reads and examines film data 136 to find the portion corresponding to characterization pattern 110, which is further examined to identify the locations of data regions, i.e., regions containing representations of video data 108, within film data 136. This examination will reveal whether the video data 108 includes a progressive or interlaced raster, and where the data regions corresponding to the frames or fields are to be found.

In order to decode the colorimetry of the film archive, i.e., to convert film densities or film density codes into digital video codes, a colorimetric look-up table can be established by the decoder based on information from the characterization pattern 110. Depending on how the characterization pattern was originally encoded in the archive (i.e., whether it was encoded using the same cLUT as the video data), this look-up table can be used to obtain information or a transformation for decoding the image data in the film archive.

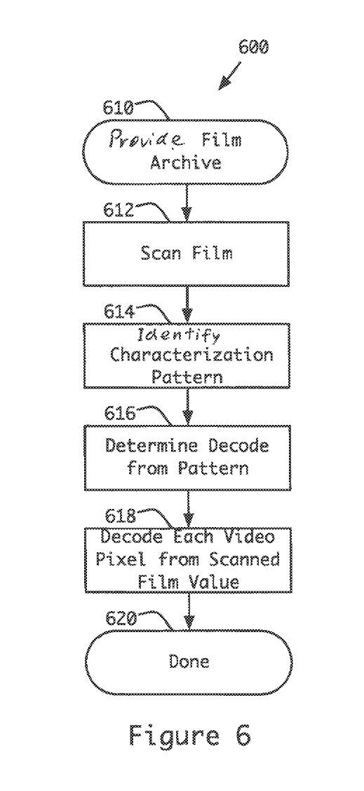

If the characterization pattern in the archive was encoded using cLUT 128, decoder 138 (based on prior knowledge or information relating to, or obtained from, the characterization pattern) recognizes which density code values in film data 136 correspond to original pixel codes in characterization pattern 110, and a colorimetric look-up table is created within decoder 138. For example, prior knowledge relating to the pattern may be predetermined or provided separately to the decoder, or information may be included in the pattern itself, either explicitly or known by convention. This look-up table, which may be sparse, is created specifically for use with decoding film data 136. Subsequently, density code values read in portions of film data 136 corresponding to video content data can be decoded, i.e., converted into video data, using this look-up table, including by interpolation, as needed. An externally provided inverse cLUT 148 is not required for decoding the archive in this embodiment because the characterization pattern contains enough information for the decoder to construct an inverse cLUT as part of the decoding activity. This is because, for the each of the video code values represented in the original characterization pattern 110, the characterization pattern embedded in the film data 136 recovered from the film archive 126 now comprises the corresponding actual film density value. The collection of the predetermined video data values and the corresponding observed film density values is, for those values, an exact inverse cLUT, which can be interpolated to handle values not otherwise represented in the internally constructed inverse cLUT. This decoding approach is further discussed and illustrated in connection with FIG. 6.

If the characterization pattern 110 in the archive was not encoded using cLUT 128, decoder 138 recognizes which density code values in film data 136 correspond to original pixel codes in characterization pattern 110 (again, based on prior knowledge regarding, or information obtained from, the pattern), and a look-up table, which may be sparse, is created within decoder 138. This look-up table is then multiplied through an inverse cLUT 148, producing a decode transformation specifically appropriate to the portion of film data 136 corresponding to video data 108. Subsequently, density code values of corresponding video data 108 in portions of film data 136 can be decoded, i.e., converted into video data format, using the decode transformation, including by interpolation, as needed. This decoding procedure can be understood as: 1) aging effects of the archive are accounted for by transforming the film density code values using the look-up table created based on the pattern, and 2) the inverse cLUT then translates or transforms the “de-aged” (i.e., with aging effects removed) density code values into video code values.

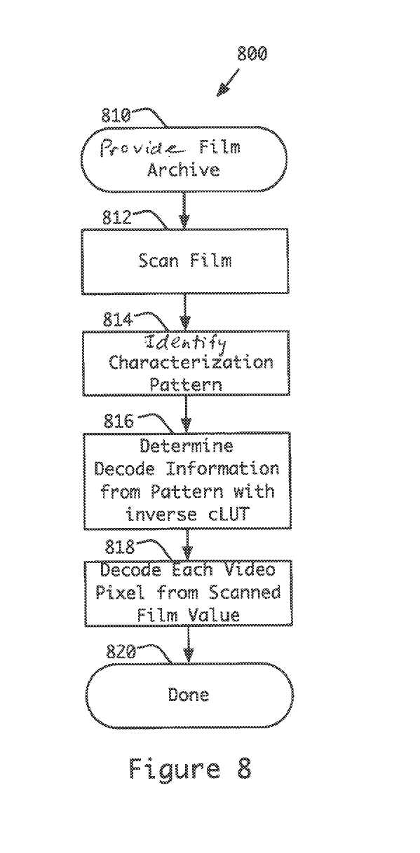

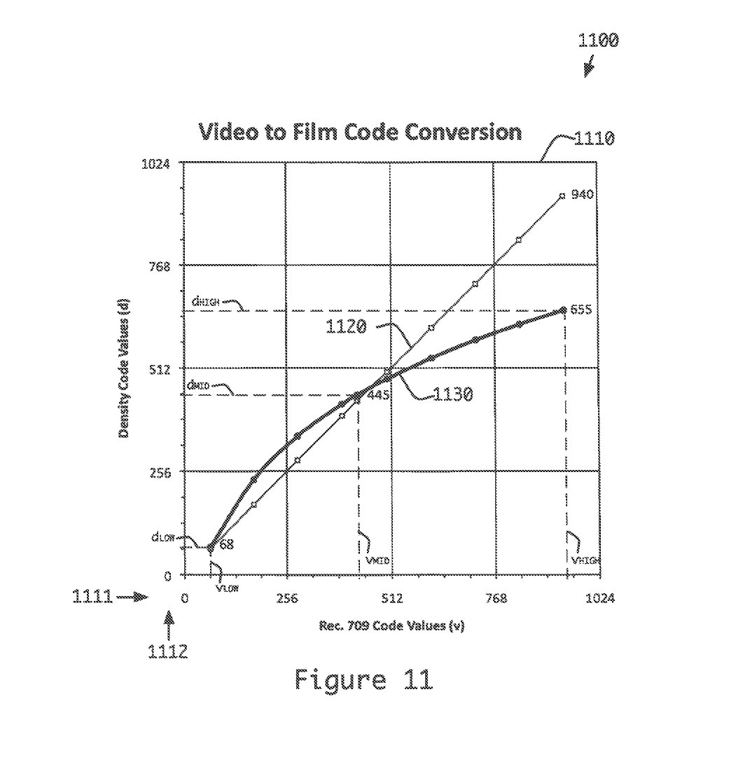

In this embodiment, the inverse cLUT 148 (which is the inverse of the cLUT 128 used for encoding the video data) is needed to recover the original video data. This decoding approach will be further discussed and illustrated in connection with FIG. 8 and FIG. 11.

Thus, video data is extracted and colorimetrically decoded by decoder 138 from film data 136, whether field-by-field or frame-by-frame, as appropriate. Recovered video data 140 is read by video output device 142, which can format the video data 140 into a video signal appropriate to video recorder 144 to produce regenerated video content 146.

Video recorder 144 may, for example, be a video tape or digital video disk recorder. Alternatively, in lieu of video recorder 144, a broadcast or content streaming system may be used, and recovered video data 140 can be directly provided for display without an intermediate recorded form.

As a quality check or a demonstration of the effectiveness of the archive making and archive reading systems 100 and 130, original video content 102 and regenerated video content 146 may be examined with video comparison system 150, which may include displays 152 and 154 to allow an operator to view the original video and the recovered video in a side-by-side presentation. In another embodiment of comparison system 150, an A/B switch can alternate between showing one video and then the other on a common display. In still another embodiment, the two videos can be shown in a “butterfly” display, which presents one half of an original video and a mirror image of the same half of the recovered video on the same display. Such a display offers an advantage over a dual (e.g., side-by-side) display because corresponding parts of the two videos are presented in similar surroundings (e.g., with similar contrasts against their respective backgrounds), thus facilitating visual comparison between the two videos. The video content 146 generated from the film archive according to the present invention will be substantially identical to that of original video content 102.

Additionally, film print output system 160 supplies film archive 126 to a well-adjusted film printer 164 (including a development processor, not separately shown) using a specific film print stock 162, to produce film print 166, which is then projected using projection system 168. When the projection of film print 166 is viewed with a display of either original video content 102 or regenerated video content 146, an operator should find that two presentations are a substantial match (i.e., no re-timing of the film color would be needed to match the video display 152/154), provided that neither film archive 126 nor film print 166 has substantially aged.

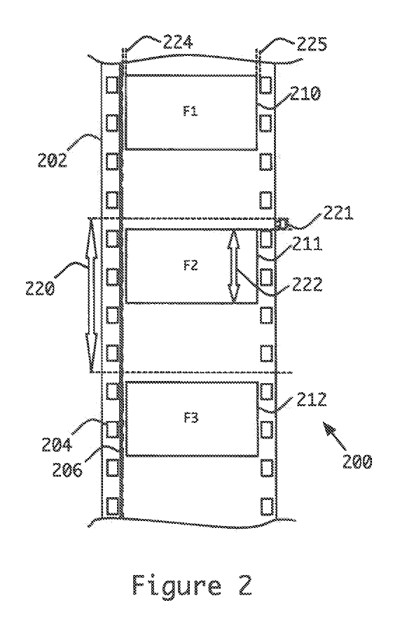

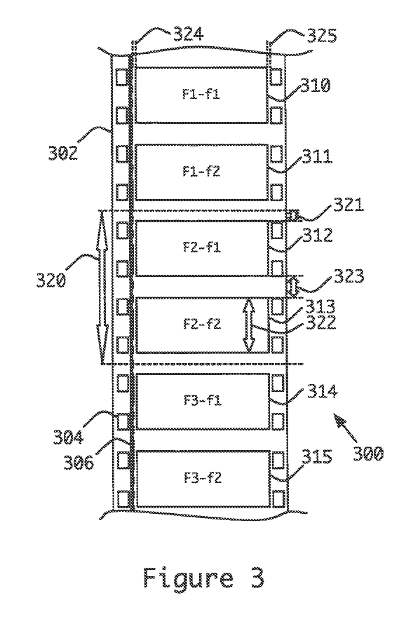

FIG. 2 and FIG. 3 show exemplary embodiments of frames of video data encoded within a film archive 126. In film archive 200, several progressive scan video frames are encoded as frames F1, F2 and F3 on the film, and in film archive 300, interlaced scan video frames are encoded as separated, successive fields such as F1-f1, F2-f2, and so on, where F1-f1 and F1-f2 denote different fields f1, f2 within the same frame F1. Film archives 200 and 300 are stored or written on film stock 202 and 302, respectively, with corresponding perforations such as 204 and 304 for establishing the respective position and interval of exemplary film frames 220 and 320. Each film archive may have an optional soundtrack 206, 306, which can be analog or digital or both, or a time code track (not shown) for synchronization with an audio track that is archived separately.

The data regions 210, 211 and 212 of film archive 200, and data regions 310, 311, 312, 313, 314 and 315 of film archive 300 contain representations of individual video fields that are spaced within their corresponding film frames (frames 220 and 320 being exemplary). These data regions have horizontal spacings 224, 225, 324, 325 from the edge of the corresponding film frames, vertical spacings 221, 321 from the beginning of the corresponding film frames, vertical heights 222 and 322, and interlaced fields have inter-field separation 323. These parameters or dimensions are all identified by the spatial and temporal descriptions provided in characterization patterns, and are described in more detail below in conjunction with FIGS. 4A-B.

FIG. 4A shows a characterization pattern 110 recorded as a header 400 within film archive 126, and in this example, for original video content 102 having interlaced fields. Film frame height 420, is the same length as a run of four perforations (illustrated as perforation 404), forming a conventional 4-perforation (“4-perf”) film frame. In an alternative embodiment, a different integer number of film perforations might be selected as the film frame height.

In the illustrated embodiment, within each 4-perf film frame, data regions 412 and 413 contain representations of two video fields (e.g., similar to fields 312, 313 in film archive 300), and may be defined by their respective boundaries. In this example, each boundary of the data region is denoted by three rectangles, as shown in more detail in FIG. 4B, which represents a magnified view of region 450 corresponding to corner portions of rectangles 451, 452 and 453 forming the boundary of data region 412. In other words, the rectangle in FIG. 4A having corner region 450 includes three rectangles: 451, 452, and 453, which are drawn on film 400 as pixels, e.g., with each rectangle being one pixel thick. Rectangle 452 differs in color and/or film density from its adjacent rectangles 451 and 453, and is shown by a hash pattern. In this example, the data region for field 412 includes pixels located on or within rectangle 452 (i.e., region 412 interior to rectangle 452, including those in rectangle 453), but excluding those in rectangle 451 or those outside. Rectangle 451 can be presented in an easily recognizable color, e.g., red, to facilitate detection of the boundary between data versus non-data regions.

Thus, in each respective data-containing frame of film archive 300, the first and second fields (e.g., F2-f1 and F2-f2) are laid out with the corresponding film frame (e.g., frame 320) exactly as regions 412 and 413 are laid out (including out to boundary rectangle 452) within characterization pattern frame 420. In this embodiment, film recorder 116 and film scanner 132 are required to accurately and repeatably position film stock 118 and film archive 126, respectively, to ensure reproducible and accurate mapping of the encoded file 114 into a film archive, and from the film archive into film data 136 during video recovery.

Thus, when read by scanner 132, rectangles 451-453 specify precisely the location or boundary of the first field in each film frame. The film recorder and film scanner operate on the principle of being able to position the film relative to the perforations with sub-pixel accuracy. Thus, relative to the four perfs 304 of film 300, each first field (e.g., F1-f1, F2-f2 and F3-f1) has the same spatial relationship to the four perfs of its frame as do the other odd fields, and likewise for the second fields F1-f2, F2-f2 and F3-f2. This identical spatial relationship holds true with the characterization pattern 400, which defines the regions where the first fields and second fields are located. Thus, region 412, as represented by its specific boundary configuration (such as rectangles 451, 452 and 453) specifies locations of first fields F1-f1, F2-f1 and F3-f1, and so on.

Similarly, rectangles around data region 413 would specify where individual second fields (e.g., F1-f2, F2-f2 and F3-f2) are to be found. For a progressive scan embodiment, a single data region with corresponding boundary (e.g., rectangles similar to those detailed in FIG. 4B) would specify where progressive frame video data regions (e.g., 210-212) would be found within subsequent film frames (e.g., 220).

The top 412T of first field 412 is shown in both FIGS. 4A and 4B, and defines head gap 421. Along with side gaps 424 and 425, and a tail gap 426 below region 413, top gap 421 is selected to ensure that data regions 412 and 413 lie sufficiently inset within film frame 420 such that film recorder 116 can reliably address the entirety of data regions 412 and 413 for writing, and film scanner 132 can reliably access the entirety of the data regions for reading. The presence of inter-field gap 423 (shown in exaggerated proportion compared to first and second fields 412 and 413) in archives of field-interlaced video content, assures that each field can be stored and recovered precisely and distinctly, without introducing significant errors in the scanned images that might arise from misalignment of the film in the scanner. In another embodiment, it is possible to have no inter-field gap 423, i.e., a gap that is effectively zero, with the two fields abutting each other. However, without an inter-field gap 423, a misalignment in the scanner can result in pixels near an edge of one field being read or scanned as pixels of an adjacent field.

The characterization pattern in film frame 420 includes, for example, colorimetric elements 430-432. The colorimetric elements may include a neutral gradient 430, which, in one example, is a 21-step grayscale covering a range of densities from the minimum to maximum in each of the color dyes (e.g., from a density of about 0.05 to 3.05 in steps of about 0.15, assuming such densities are achievable from film stock 118 within new film archive 126). As previously mentioned, a density gradient can be used as a self-calibrating tool for the effects of aging. For example, if the bright end (i.e., minimum density) of gradient 430 is found to be 10% denser when scanned sometime in the future, decoder 138 can correct for such aging effects by reducing the lightest or lowest densities in the archive film by a corresponding amount. If the dark end (i.e., maximum density) of the gradient is 5% less dense, then similar dark pixels in the archive film will be increased by a corresponding amount. Furthermore, a linear interpolation for any density value can be made based on two readings from the gradient, and by using additional readings across gradient 430, the system can compensate for non-linear aging effects.

The colorimetric elements may also include one or more primary or secondary color gradient 431, which, in one example, is a 21-step scale from about minimum density to maximum density of substantially only one dye (for measuring primary colors) or two dyes (to measure secondary colors). Similar to that described above for the neutral density gradient, density drifts arising from aging of individual dyes can also be measured and compensation provided.

For a more complete characterization, the colorimetric elements may include a collection of patches 432 which represent specific colors. An exemplary collection of colors would be generally similar those found in the ANSI IT8 standards for color communications and control, e.g., IT8.7/1 R2003 Graphic Technology—Color Transmission Target for Input Scanner Calibration, published by the American National Standards Institute, Washington, D.C., that are normally used to calibrate scanners; or the Munsell ColorChecker marketed by X-Rite, Inc. of Grand Rapids, Mich. Such colors emphasize a more natural portion of a color gamut, providing color samples more representative of flesh tones and foliage than would either grayscales or pure primary or secondary colors.

The characterization pattern may be provided in the header of a single film frame 420. In an alternative embodiment, the characterization pattern of frame 420 may be reproduced identically in each of several additional frames, with the advantage being that noise (e.g., from a dirt speck affecting the film recording, processing or scanning) can be rejected on the basis of multiple readings and appropriate filtering. In still another embodiment, the characterization pattern may be provided in the header over multiple film frames (not shown) in addition to film frame 420, for example to provide still more characterization information (e.g., additional color patches or stepped gradients). For example, a characterization pattern may include a sequence of different test patterns provided over a number film frames, e.g., a test pattern in a first frame for testing grayscale, three different test patterns in three frames for testing individual colors (e.g., red, green and blue, respectively), and four more frames with test patterns covering useful foliage and skin tone palettes. Such a characterization pattern can be considered as one that extends over eight frames, or alternatively, as different characterization patterns provided in eight frames.

FIG. 5 shows an example of process 500 for creating a printable video archive on film. Process 500, which can be implemented by a film archive system such as that in FIG. 1A, begins at step 510, with digital video data 108 being provided to (or accepted by) an encoder 112. At step 512, a corresponding characterization pattern 110 associated with the video data is also provided. The characterization pattern, which has a format compatible with the encoder (and also compatible with a decoder for recovering the video), can be provided as a text file with information relevant to the video data, or as image(s) to be incorporated with the video frames. Such incorporation can be done by pre-pending as headers (to form a leader with the characterization pattern) or be included or as composite with one or more frames of image data, but in readable/writable regions not containing image data such as intra-frame gap regions. The characterization pattern includes one or more elements designed for conveying information relating to at least one of the following: video format, time codes for video frames, location of data regions, color or density values, aging of film archive, non-linearities or distortions in film recorder and/or scanner, among others.

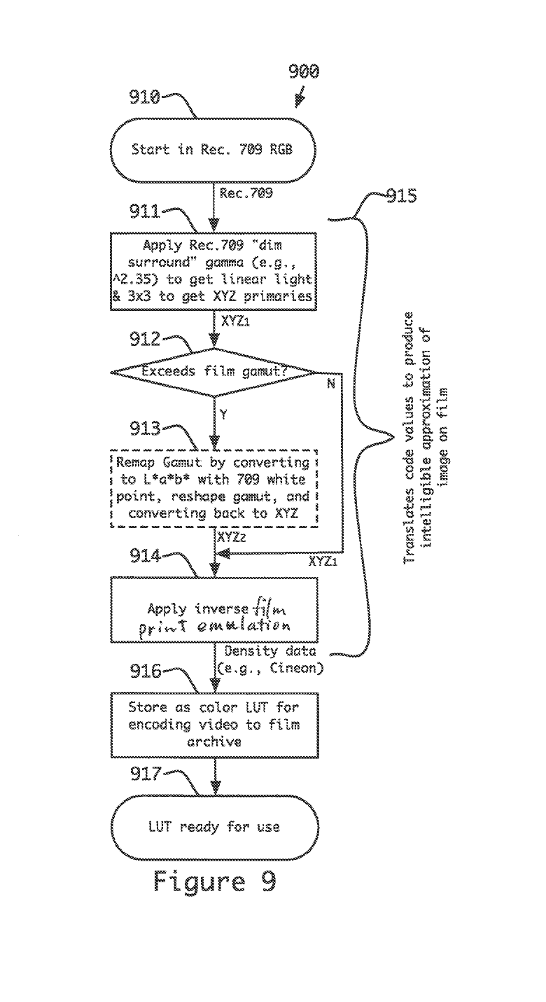

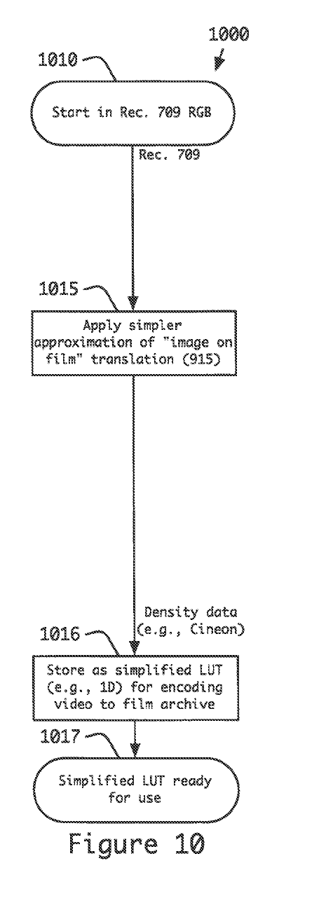

At step 514, all pixel values of the video data 108 (e.g., in Rec. 709 format) and characterization pattern 110 are encoded using the cLUT 128 (the creation of which is discussed below in conjunction with FIGS. 9 and 10) to produce encoded data 114, which are density code values corresponding to the respective pixel values. Depending on the layout described by the characterization pattern, the characterization pattern and video data pixels may both be present or co-resident in one or more frames of encoded data 114, or the pattern and video data pixels may occupy separate frames (e.g., as in the case of pre-pending the pattern as headers).

Encoding the pixel values of characterization pattern or the video data using cLUT means that the data of the pattern or video is converted to the corresponding density code values based on a non-linear transformation. Curve 1130 of FIG. 11 is an example of a cLUT, which provides a non-linear mapping or correlation between video code values and density code values. In this example, the original pixel codes from various elements in the characterization pattern, e.g., the neutral gradient 430, primary or secondary color gradient 431, or specific color patches 432, are represented by actual data points (dots) on the curve 1130.

At step 516, the encoded data 114 is written to film stock 118 by film recorder 116. With the recorder having been calibrated based on a linear relationship between density code values (e.g., Cineon code values) and film density values, latent images are formed on the film negative by proper exposures according to respective density code values. In step 518, the exposed film stock is processed or developed using known or conventional techniques to produce film archive 126 at step 520.

Printable film archive 126 can be printed to film, or converted directly to video with a telecine, depending on the cLUT 128 used. A cLUT 128 might be optimized for printing to a particular film stock, or for use on a telecine having a particular calibration. Printing on a different film stock, or using on a differently calibrated telecine will have, predictably, lower fidelity results. The purpose of the cLUT is to map the original video Rec. 709 code values to a set of film density values best suited for direct use in the target application, yet still allow recovery of the original Rec. 709 code values.

FIG. 6 shows an example of a process 600 for recovering video content from a printable film archive (which can be an aged archive) made by archive creation process 500. At step 610, the film archive, e.g., archive 126 from FIG. 1A, is provided to a film scanner, which produces film data 136 by reading and converting densities on the film archive into corresponding film density code values such as Cineon codes. Depending on the specific archive and characterization pattern, it is not necessary to scan or read the entire film archive, but instead, at least one or more data regions, i.e., portions containing data corresponding to the video content. For example, if the characterization pattern contains only spatial and temporal information about the video data (no colorimetric information), then it may be possible to identify the correct video data portions without even having to scan the characterization pattern itself. (Similar to the film recorder, the scanner has also been calibrated based on a linear relationship between density code values and film density values.)

In step 614, based on prior knowledge regarding the characterization pattern, decoder 138 picks out or identifies the record of characterization pattern 110 from film data 136. In step 616, decoder 138 uses the characterization pattern, and/or other prior knowledge relating to the configuration of various elements (e.g., certain patches corresponding to a grayscale gradient starting at white and proceeding in ten linear steps, or certain patches representing a particular order set of colors), to determine decoding information appropriate to the film data 136, including the specification for the location and timing of data regions, and/or colorimetry. As previously discussed, since the characterization pattern in this embodiment is encoded by using the same cLUT as for the video data, it contains sufficient information for the decoder to obtain or construct an inverse cLUT as part of the decoding activity. In step 618, decoder 138 uses the decode information from step 616 to decode data regions within archive 126 that contains video data, converting the film density code values to produce video data. Process 600 completes at step 620 with the video being recovered from video data.

FIG. 7 illustrates another process 700 for creating a printable video archive on film. At step 710, digital video data 108 is provided to or received by an encoder. At step 712, the value of each pixel of the video data 108 is encoded using the cLUT 128, i.e., the video data is converted from a digital video format (e.g., Rec. 709 code value) to a film-based format such as density code value. Again, curve 1130 of FIG. 11 is an example of a cLUT.

At step 714, a corresponding characterization pattern 110, i.e., a pattern associated with the video data, is also provided to the encoder. Encoded data 114 includes the video data encoded using the cLUT, and the characterization pattern, which is not encoded using cLUT 128. Instead, the characterization pattern is encoded by using a predetermined relationship, such as a linear mapping to convert video code values of the color patches in the pattern to density code values.

In one embodiment, the pattern's data is encoded by converting from Rec. 709 code values to density code values based on a linear function represented by line 1120 in FIG. 11 (in this example case, line 1120 has a slope of 1, such that the Rec. 709 code value is exactly the same as the density code value).

As mentioned above, the characterization pattern and the video data can be provided separately in different frames (e.g., as in FIG. 4), or the characterization pattern can be included a frame that also contains image data, e.g., in the non-image data areas (as in intraframe gap 323).

At step 716, encoded data 114 is written with film recorder 116 to film stock 118, which is processed at step 718 to produce film archive 126. Printable archive creation process 700 completes at step 720. In this embodiment, the characterization pattern has not be encoded with cLUT 128 at step 712.

As with the product of process 500, archive 126 from process 700 can be printed to film, or converted directly to video with a telecine, with similar results.

FIG. 8 illustrates process 800 for recovering video from a printable film archive 126 made by archive creation process 700. At step 810, the printable film archive 126 (e.g., can be an “aged” archive) is provided to a scanner, such as film scanner 132 of FIG. 1B. At step 812, film data 136 is produced by converting the scanned readings from film densities to density code values. At step 814, based on prior knowledge regarding the characterization pattern, decoder 138 picks out or identifies the characterization pattern from film data 136. At step 816, the characterization pattern, and/or prior knowledge relating to various elements in the pattern, is used to determine decoding information appropriate to the film data 136. The decoding information includes the specification for the location and timing of data regions, a normalized colorimetry, and to complete the colorimetry specification, an inverse cLUT 148 (which is the inverse of the cLUT used for encoding the video data during film archive creation). At step 818, decoder 138 uses the decode information from step 816 to decode data regions within archive 126 that contains video data, and converts from film density codes to produce video data. The video is recovered from the video data at step 820.

This encode-decode method of FIGS. 7-8 (in which only the video data is encoded with the cLUT such as curve 1130 of FIG. 11, and the pattern is encoded based on a linear transformation such as line 1120 of FIG. 11) characterizes how the entire density range of the film has moved or drifted with age, whereas the method of FIG. 5-6 (both the video data and the characterization patterns are encoded using the cLUT) characterizes not only how the sub-range of film density values used for encoding image data has drifted, but also embodies the inverse-cLUT so that, when decoding, the inverse-cLUT is not separately required or applied. In the method of FIGS. 7-8, the locations of d_{low}, d_{high} and d_{mid} on curve 1130 of FIG. 11 cannot be determined from the characterization pattern without retaining the original cLUT used in encoding video data for a reverse lookup.

Other variations of the above processes may involve omitting the characterization pattern, or a portion thereof, from the film archive, even though it is used for encoding purpose and provided in the encoded file. In this case, additional information may be needed for a decoder to properly decode the film archive. For example, if the position of images and the densities are prescribed by a standard, then there is no need to include the characterization pattern in the film archive. Instead, prior knowledge of the standard or other convention will provide the additional information for use in decoding. In this and other situations that do not require scanning the characterization pattern, steps 614 and 814 in processes 600 and 800 may be omitted. Another example may involve including only a portion of the pattern, e.g., color patches, in the film archive. Additional information for interpreting the patches can be made available to the decoder, separate from the film archive, for decoding the archive.

Before discussing methods for creating a cLUT for use in producing film archives of the present invention, additional details and background relating to cLUT are presented below. The use of cLUT is known in computer graphics and image processing. A cLUT provides a mapping from a first pixel value (the source) to a second pixel value (the destination). In one example, the cLUT maps a scalar value in Rec. 709 code value to a scalar value in density code (e.g., line 1130 in FIG. 11, with a Rec. 709 code representing only a single color component such as one of red, green, or blue of the pixel). The single-value LUT is appropriate for systems where the crosstalk is absent or, for the purpose at hand, negligible. Such a cLUT can be represented by a one-dimensional matrix, in which case the individual primaries (red, green, blue) are treated individually, e.g., a source pixel with a red value of 10 might be transformed into a destination pixel with a red value of 20, regardless of the source pixel's green and blue values.

In another example, the cLUT maps a color triplet of a pixel (e.g., three Rec. 709 code values for R, G and B) representing the source value to a corresponding triplet of density codes. This representation is appropriate when the three color axes are not truly orthogonal (e.g., due to crosstalk between the red-sensitive and green-sensitive film dyes as might result if the green-sensitive dye were to be slightly sensitive to red light, too, or if the green-sensitive dye when developed, had non-zero absorption of other than green light).

This cLUT can be represented as a three-dimensional (3D) matrix, in which case the three primaries are treated as a 3D coordinate in a source color cube to be transformed into a destination pixel. In a 3D cLUT, the value of each primary in the source pixel may affect any, all, or none of the primaries in the destination pixel. For example, a source pixel with a red value of 10 might be transformed into a destination pixel with a red value of 20, 0, 50, etc., depending further on the values of the green and/or blue components.

Often, especially in systems having a large number of bits representing each color component (e.g., 10 or more), a cLUT may be sparse, i.e., only a few values are provided in the LUT, with other values being interpolated for its use, as needed. This saves memory and access time. For example, a dense 3D cLUT, with 10-bit primary values, would require (2̂10)̂3 (where 2̂10 denotes 2 to the power of 10), or slightly more than 1 billion entries to provide a mapping for each possible source pixel value. For a cLUT that is well-behaved, i.e., no extreme curvatures nor discontinuities, a sparse cLUT may be created and values for destination pixels interpolated by well-known methods involving prorating the nearest neighbors (or the nearest neighbors, and their neighbors) based on the relative distances of their corresponding source pixels from the source pixel of interest. An often reasonable density for a spares cLUT for Rec. 709 values is 17̂3, that is, 17 values for each color primary, along each axis of the color cube, which results in slightly less than 5000 destination pixel entries in the cLUT.

FIG. 9 illustrates a process 900 for creating an appropriate cLUT for use in this invention, e.g., cLUT 128 in FIG. 1A. In this example, the intent is to create a cLUT that will transform the video code values into film density code values suitable for exposing negative stock 118 in film recorder 116 and the resulting film archive 126 is optimally suited for making a film print 166 such that an operator examining the output from projection system 168 and either of displays 152 and 154 would perceive a substantial match.

Process 900 starts at step 910, with the original video code space, in this example Rec. 709, specified as being scene-referred.

At step 911, the video data is converted from its original color space (e.g., Rec. 709) to an observer-referred color space such as XYZ, which is the coordinate system of the 1931 CIE chromaticity diagram. This is done by applying an exponent to the Rec. 709 code values (e.g., 2.35 or 2.4, as gamma values appropriate to a “dim surround” viewing environment considered to be representative of a typical living room or den used for television viewing). The reason for the conversion to an observer-referred color space is because the purpose of the cLUT is to make a film to look like the video, as nearly as possible, when presented to an observer. This is most conveniently achieved in a color space that treats the observer as the reference point (hence the terminology, “observer-referred”).

Note that the terms “scene-referred” or “output-referred”, known to one skilled in the art, are used to specify what a code value actually defines in a given color space. In the case of Rec. 709, “scene-referred” means referring to something in the scene, specifically, to an amount of light reflecting off a calibration card (a physical sheet of cardboard with specially printed, specially matte patches of color on it) in view of the camera (the white of the card should be code value 940, the black of the card, code value 64, a particular gray patch is also defined, which sets parameters for an exponential curve). “Output-referred” means that a code value should produce a particular amount of light on a monitor or projection screen. For example, how many foot-Lamberts of light a screen should emit for a code. Rec. 709 specifies what color primaries should be used and what color corresponds to white, and so there is some sense of “output referred” in the standard, but the key definitions for code values were “scene-referred”.) “Observer-referred” is linked to how human beings perceive light and color. The XYZ color space is based on measurements of how human beings perceived color, and is unaffected by things like what primary colors a system uses to capture or display an image. A color defined in XYZ space will look the same regardless of how it is produced. Thus, two presentations (e.g., film and video) that correspond to the same XYZ values will look the same. There are other observer referred color spaces, e.g., Yuv, Yxy, etc., which are all derived from either the 1931 CIE data, or more modern refinements of it, which have slightly changed certain details.

At step 912, a check or inquiry is made to determine whether the resulting gamut, i.e., the gamut of the image data after conversion to the observer-referred color space (identified as XYZ₁) significantly exceeds that representable in film (what would constitute “significant” is a matter of policy, likely concerning, among other things, both the degree by and duration for which the film gamut would be exceeded). If a determination is made that the film gamut is not significantly exceeded, then the observer-referred codes (in gamut XYZ₁) are passed to step 914. The film gamut refers to a locus of all colors that can be represented on the film medium. A film gamut is “exceeded” when there are colors called for that cannot be expressed in film. The gamut of film exceeds that of video in some places (e.g., saturated cyans, yellows, magentas) and the gamut of video exceeds that of film in other places (e.g., saturated reds, greens, and blues).

Otherwise, if at step 912 there is a concern that the gamut in XYZ₁ would significantly exceed that of a film print 166, then the gamut is remapped at step 913 to produce codes in a reshaped gamut (still in the XYZ color space, but now identified as XYZ₂). Note that the gamut is not the color space, but a locus of values in a color space. Film's gamut is all possible colors expressible in film, video's gamut is all possible colors expressible in video, and the gamut of a particular video data (e.g., video data 108) is the collection of unique colors actually used in totality of that video data. By expressing it in XYZ color space, the gamuts of otherwise unlike images (film is an absorptive media, video displays are emissive) can be compared.

Numerous techniques for gamut remapping are known, and the most successful are hybrids combining results from different techniques in different regions of the gamut. In general, gamut remappings are best conducted in a perceptually uniform color space (a special subset of observer-referred color spaces), the CIE 1976 (L*, a*, b*) color space (CIELAB) being particularly well suited. Thus, in one embodiment of gamut remapping step 913, the codes in the XYZ₁ gamut are converted into CIELAB using the Rec. 709 white point (the illuminant), the resulting codes remapped to substantially not exceed film gamut, and then reconverted back to the XYZ color space to produce the modified gamut XYZ₂, now having the property of not significantly exceeding the available film gamut.

The value or advantage of performing the remapping of the gamut in CIELAB rather than XYZ color space is so that changes made to certain colors of a particular scale are similar in degree of perceived change as are changes of the same scale made elsewhere in the gamut, i.e., to other colors (which is a property of CIELAB, since it is perceptually uniform). In other words, in CIELAB space, the same change by a certain amount along any of the axes in the color space, in any direction, is perceived as a change of the “same size” by humans. This helps to provide a gamut remapping that does not produce disconcerting or otherwise excessive artifacts as colors are modified in one direction in some regions of the gamut and a different direction (or not at all) in other regions of the gamut. (Since a video display has a color gamut that is different from a film gamut, there will be certain colors in the video gamut that are absent in the film gamut. Thus, if a bright, saturated green in the video gamut cannot be found in the film gamut, then that green color would be remapped by moving it in (generally speaking) the minus-y direction in the XYZ space. This would have the effect of trending that particular green to be less saturated (moving “white-ward” towards the white region of a CIE chart for the XYZ space). However, as the green in the gamut is remapped to a paler green, other green colors in the original video gamut may also need to be moved or modified in a similar direction, but perhaps by a different amount, so as to keep the effect somewhat localized in the gamut.)

For example, if certain saturated greens are called for in video data 108, but these are outside of the gamut reproducible by film print 166, then these saturated greens in video data 108 would be made less saturated and/or less bright during remapping step 913. However, for other nearby values, which might not have exceeded the available film gamut, a remapping will be necessary to avoid an overlap with those values that must be remapped. Further, more than just avoiding an overlap, an effort should be made to make the remapping as smooth as possible (in perceptual color space) so as to minimize the likelihood of visible artifacts (e.g., Mach bands).

At step 914, the codes within the natural gamut (XYZ₁) or remapped gamut (XYZ₂) are processed through an inverse film print emulation (iFPE). The iFPE can be represented as a function or cLUT representing the function, just as other cLUTs are built (although for a different reason and with a different empirical basis). In this case, the cLUT representing the iFPE converts XYZ color values into film density codes, and may be implemented as a 3D cLUT. A film print emulation (FPE) is a characterization of film stocks 118 and 162 and the illuminant (projector lamp & reflector optics) of projection system 168 that translates a set of density values (e.g., Cineon codes) that would be provided to a film recorder 116 into the color values that would be expected to be measured when viewing projection system 168. FPEs are well known in digital intermediate production work for the motion picture industry, because they allow an operator working from a digital monitor to make color corrections to a shot and count on the correction looking right in both digital and film-based distributions of the movie.

As in the description of sparse cLUTs above, an FPE may be adequately represented as a 17×17×17 sparse cLUT, with excellent results. It is a straight forward mathematical exercise (well within ordinary skill in the art) to invert an FPE to produce the iFPE. However in many instances the inverse of a 17×17×17 cLUT may not provide adequate smoothness properties and/or well-behaved boundary effects. In such cases, the FPE to be inverted may be modeled in a less-sparse matrix, e.g., 34×34×34, or using a non-uniform matrix having denser sampling in regions exhibiting higher rates of change.

The result of the iFPE at step 914 is to produce the film density codes (e.g., Cineon codes) that correspond to the XYZ values of the provided gamut, i.e., gamut of Rec. 709. Thus, the aggregate transform 915, translates video code values (e.g., Rec. 709) into density codes usable in encoded file 114 for producing a film negative, which when printed will produce an intelligible approximation of the original video content 102 on film, as in print 166. The film density codes corresponding to the initial video codes at step 910 are stored at step 916 as cLUT 128. The cLUT creation process 900 concludes at step 917, having generated cLUT 128. The cLUT can be either 1D or 3D.

FIG. 10 shows another cLUT creation process 1000, which begins at step 1010 with video codes (again, using Rec. 709 as an example). At step 1015, a simpler approximation of the aggregate function 915 is used to represent the transform from video code space to film density data (again, using Cineon codes as an example). One example of simplification is to skip steps 912 and 913. Another simplification could be to combine the Rec. 709 to XYZ to density data into a single gamma exponent and 3×3 matrix, perhaps including enough scaling to ensure that the film gamut is not exceeded. Note, however, that such simplifications will produce a decrease in the quality of the image when the archive is printed. Such simplifications may or may not change the quality of the video data recovered. At step 1016, values are populated in a simplified cLUT, which may be as dense as in step 916, or may be more simply modeled, e.g., as a 1-dimensional (1D) LUT for each of the primary colors. At step 1017, this simplified cLUT is available for use as cLUT 128.

FIG. 11 shows a graph 1110 representing an exemplary conversion from Rec. 709 code values 1111 to Cineon density code values 1112.

Linear mapping or function 1120 can be used to make a film archive of video content which is not intended to be printed, as its properties are intended to optimize the ability of writing and recovering code values (through film recorder 116 and film scanner 132) with optimal or near optimal noise distribution (i.e., each code value written is represented by the same sized range of density values on film). In this example, linear mapping 1120 maps the range (64 to 940) of Rec. 709 code values to like-valued (and “legal”, i.e., compliant with Rec. 709) Cineon code values (64 to 940). A method incorporating such an approach is taught by Kutcka et al. in U.S. Provisional Patent Application No. 61/393,858, entitled “Method and System of Archiving Video to Film”. However, linear mapping 1120 is poorly suited for a film archive from which a film print 166 or telecine conversion is expected to be made, because the dark colors will appear too dark, if not black, and the light colors will appear too bright, if not clipped white.

Non-linear mapping or function 1130, as might be described by cLUT 128 (for clarity shown here as a 1D cLUT), is the result, in a single dimension (rather than 3D), of process 900. In this example, namely applying to the Rec. 709 video code value range (64 . . . 940), normalized to that standard's linear light values, raised to an exponent of γ_{VIDEO}=2.35 (a suitable gamma for a “dim surround” viewing environment, though another common choice is 2.40), which produces a range for linear light values “l(v)” as shown in the following equation:

$$l ( v ) = {( \frac{( v - {v}_{LOW} )}{( {v}_{HIGH} - {v}_{LOW} )} \times ( {l}_{HIGH}^{1 / {γ}_{VIDEO}} - {l}_{LOW}^{1 / {γ}_{VIDEO}} ) )}^{{γ}_{VIDEO}} \qquad EQ . 1$$

in which v_{LOW}=64 and v_{HIGH}=940 are the lower and upper code values, each corresponding respectively to linear light values l_{LOW}=90% and l_{HIGH}=1%. This comes from the specification in Rec. 709 that the value of 64 should be the code value assigned to a black (1% reflectance) test patch, and the value of 940 should be the code value assigned to a white (90% reflectance) test patch, hence the earlier statement that Rec. 709 is “scene-referred”. Note that for embodiments using other video data codes, different values or equations may be used.

For conversion to film density codes, a midpoint video code v_{MID} is determined, corresponding to the video code value that would correspond to a grey (18% reflectance) test patch, i.e., satisfying the equation:

l(r_{MID})=0.18 EQ. 2:

Solving EQ. 1 and EQ. 2 for v_{MID} gives a value of about 431. In the Cineon film density codes, a film density code value d_{MID} also corresponding to a grey (18% reflectance) test patch, is 445. A common film gamma is γ_{FILM}=0.60, though other values may be selected, depending on the negative film stock 118 being used. Cineon film density codes provide a linear change in density per increment, and density is the logᵢₙ of the reciprocal of transmissivity, thus an additional constant s=500 specifies the number of steps per decade. With these values established, the translation from video code value to film density value is expressed in this equation:

d(v)=γ_{FILM}·s·(log₁₀(l(v))−log₁₀(l(v_{MID})))+d_{MID} EQ. 3

The non-linear mapping 1130 in graph 1110 is a plot of d(v) for video codes in the range of 64 to 940. For example, d_{LOW}=d(v_{LOW}=64)=68, d_{MID}=d(v_{MID}=431)=445, and d_{HIGH}=d(v_{HIGH}=940)=655. Note that density codes would be rounded to the nearest integer value.

For the non-linear characteristic of curve 1130, for video code values (v) less than about 256, incremental video codes “v” may result in non-consecutive film density codes “d” since, in this region, the slope of curve 1130 is greater than one. (For example, instead of having consecutive film density codes like 1, 2 and 3 that correspond to consecutive or incremental video codes, the density codes in the sequence might be 1, 4, 7. When a density reading is made by scanning the film archive, perhaps with a little noise, the density readings of 3, 4, or 5 would all map to the video code that corresponds to the density code of 4. Hence, these density readings have some degree of noise immunity.) For video code values greater than about 256, the slope of curve 1130 is less than one, and incremental video codes may result in duplicative density codes, when rounding to integers, i.e., there may be two different video code values above 256 that have the same density code value. (As an example, for a density code of 701, there might be two different video codes corresponding to that density code. If a density code is read back with an error of one count in density, that may result in a video code that could differ by several counts. Thus, in this region, the readings and conversion back are extra noisy.) As a result, when recovering video codes from film archive 126, brighter portions of the image will be slightly noisier and dark portions of the image slightly less noisy than video codes recovered from a video archive on film using 1:1 linear conversion 1120. However, this tradeoff is worthwhile when the ability to print the archive to film or scan with a telecine is required. (Note that since linear conversion function 1120 has a larger maximum density compared to curve 1130, a film archive from that linear conversion approach will result in a film print for which the bright colors will be blown out, i.e., excessively bright. Similarly, the dark colors of the film print will be darker than the corresponding dark colors of a film print made using curve 1130. The effect is that printing from a film archive made by using linear conversion 1120 would produce a film print with too high a contrast, e.g., to the point that most of the image is too dark or too bright.)

In the above examples, a LUT is used as an efficient computational tool or method, as a “shorthand” to cover a more general transform, which can optionally be modeled as a computable function. If desired, the actual equation representing the transform can be determined, and computations made repeatedly to obtain corresponding code values for each pixel or value to be translated or transformed. The cLUT, whether in 1D or 3D, sparse or otherwise, are possible implementations for processing the transform. The use of a cLUT is advantageous because it is generally inexpensive to use in computation, which will occur millions of times per frame. However, creation of different cLUTs can require different amounts of computation (or different numbers and kinds of measurements, if the cLUT must be built empirically because the actual transform is unknown, too difficult to compute, or difficult to obtain parameters for).

While the foregoing is directed to various embodiments of the present invention, other embodiments of the invention may be devised without departing from the basic scope thereof. For example, one or more features described in the examples above can be modified, omitted and/or used in different combinations. Thus, the appropriate scope of the invention is to be determined according to the claims that follow.

1. A method for archiving video content on film, comprising:
encoding digital video data by at least converting the digital video data into film density codes based on a non-linear transformation;
providing encoded data that includes the encoded digital video data and a characterization pattern associated with the digital video data;
recording the encoded data onto film in accordance with the film density codes; and
producing a film archive from the film having the recorded encoded data.

2. The method of claim 1, wherein the characterization pattern in the encoded data is encoded by converting pixel values of the characterization pattern into film density codes based on the non-linear transformation.

3. The method of claim 1, wherein the characterization pattern in the encoded data is encoded by converting pixel values of the characterization pattern into film density codes based on a linear transformation.

3. The method of claim 1, wherein the encoding is performed using a color look-up table representing the non-linear transformation.

4. The method of claim 1, wherein the characterization pattern provides at least one of temporal, spatial and colorimetric information relating to the digital video data.

5. The method of claim 1, wherein the characterization pattern includes at least one of time codes for video frames, elements indicating location of video data on the film archive, and color patches representing predetermined pixel code values.

6. The method of claim 1, wherein the characterization pattern includes at least one of data, text and graphics elements.

7. The method of claim 1, wherein the characterization pattern further comprises:
at least one of a density gradient and color patches representing different color components.

8. The method of claim 1, wherein the non-linear transformation is created by:
converting the digital video data from an original color space to an observer-referred color space having a color gamut not exceeding a color gamut of the film;
converting code values of the digital video data in the observer-referred color space into film density codes using an inverse film print emulation transformation;
storing the converted film density codes for use as the non-linear transformation.

9. A method for recovering video content from a film archive, including:
scanning at least a portion of the film archive containing digital video data encoded as film-based data and a characterization pattern associated with the digital video data; wherein the digital video data has been encoded into film-based data by a non-linear transformation; and
decoding the film archive based on information contained in the characterization pattern.

10. The method of claim 9, wherein pixel values of the characterization pattern in the film archive have been encoded to film-based data by the non-linear transformation.

11. The method of claim 9, wherein the characterization pattern provides at least one of temporal, spatial and colorimetric information relating to the digital video data.

12. The method of claim 9, wherein the characterization pattern includes at least one of data, text and graphics elements.

13. The method of claim 9, wherein the decoding is performed based on information relating to the non-linear transformation.

14. A system for archiving video content on film, comprising:
an encoder for producing encoded data containing film-based data corresponding to digital video data and a characterization pattern associated with the video data, wherein the digital video data and pixel values of the characterization pattern are encoded to the film-based data by a non-linear transformation;
a film recorder for recording the encoded data onto a film; and
a film processor for processing the film to produce a film archive.

15. A system for recovering video content from a film archive, comprising:
a film scanner for scanning the film archive to produce film-based data;
a decoder for identifying a characterization pattern from the film-based data, and for decoding the film-based data based on the characterization pattern to produce video data for use in recovering the video content; wherein the film-based data is related to the video data by a non-linear transformation.
